(19) United States
(12) Patent Application Publication
(10) Pub. No.: US 2010/0007899 A1
(43) Pub. Date: Jan. 14, 2010

(54) METHOD TO PRINT A RECORDING MEDIUM WITH COLOR DATA AND MICR DATA

(76) Inventor: HEINRICH LAY, Toeging am Inn (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/502,249

(22) Filed: Jul. 14, 2009

(30) Foreign Application Priority Data
Jul. 14, 2008 (DE) 10 2008 032 988.6

(51) Int. Cl. H04N 1/00

(52) U.S. Cl. 358/1.6

(57) ABSTRACT

In a method or system for printing a recording medium with color data and MICR data, a color printing device and at least one MICR printing device are arranged independent and separate from one another. The color printing device prints both the color data and the MICR data in encoded form as code data onto the recording medium. The recording medium is supplied to the at least one MICR printing device. The MICR data are decoded from the code data, and the MICR data are subsequently printed on the recording medium via the at least one MICR printing device.

### BACKGROUND

It is known to implement a combined color printing and MICR printing on one recording medium, for example a paper web. One use case for this is the printing of check forms. The generation of the check form occurs via a color printing device. Magnetically-readable data are then imprinted in the check form by a MICR printing examination volume. In the following the data to be printed on the recording medium by the color printing device are designated as color data and the data to be printed on the recording medium by the MICR printing device are designated as MICR data, wherein MICR stands for “Magnetic Ink Character Recognition”. What are to be understood by a color print are full color prints but also single color prints.

From US RE38,957 E it is known how information printed on a recording medium can be inspected, which information being printed on the recording medium via a color printing device or a MICR printing device. For this respective readers are provided that can read a barcode, that can read optical information or that can read magnetic information.

A printer that is designed such that it can ink charge images on a charge image substrate with both MICR toner and with standard toner is known from U.S. Pat. No. 6,236,816 B1. In order to achieve this goal, two developer stations are provided, one filled with MICR toner and one with standard toner. One of the two developer stations can optionally be used to develop the charge images on the charge image substrate.

U.S. Pat. No. 7,010,242 B2 describes a printing system made up of two printing devices between which is arranged one transfer unit for the recording medium. The printing devices can print images on the recording medium in different ways. For example, the first printing device can print images inked with MICR toner onto the recording medium and the second printing device can print images inked with standard toner. The printing devices are designed identically and can be swapped.

One problem in the sequential printing of a recording medium (for example of paper) with different printing devices is frequently that the one printing device (for example a color printing device) can print the recording medium with higher speed than the other printing device (for example an MICR printing device). For example, if a high-capacity inkjet printer is used as a color printing device for web-shaped recording media (what is known as continuous feed printing), this can print the recording medium in full color (for example CMYK) at up to 2.5 m/s. A comparable print speed is normally not achieved by an electrographic MICR printing device. Given a printing system made of a combination of such a color printing device and MICR printing device, the print speed of the printing system is then determined by the slower MICR printing device.

### SUMMARY

It is an object to specify a method and a printing system with which MICR printing and color printing can be combined on one (in particular web-shaped) recording medium without the print speed of the color printing device having to be adapted to that of the MICR printing device.

In a method or system for printing a recording medium with color data and MICR data, a color printing device and at least one MICR printing device are arranged independent and separate from one another. The color printing device prints both the color data and the MICR data in encoded form as code data onto the recording medium. The recording medium is then supplied to the at least one MICR printing device. The MICR data are decoded from the code data, and the MICR data are subsequently printed on the recording medium via the at least one MICR printing device.

### BRIEF DESCRIPTION OF THE DRAWINGS

FIG. 1 is a principle representation of a printing system with a color printing device and multiple MICR printing devices;

FIG. 2 shows various arrangements of a barcode on a recording medium with check forms;

FIG. 3 is a first realization of the MICR printing device with external evaluation of the code data; and

FIG. 4 is a second realization of the MICR printing device with internal evaluation of the code data.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The preferred embodiment provides a method for printing a recording medium with color data and MICR data,
in which a color printing device and at least one MICR printing device are arranged independent of and separate from one another,
in which the color printing device prints both the color data and the MICR data (but these in encoded form as code data) onto the recording medium,
in which the recording medium is supplied to the at least one MICR printing device,
in which the MICR data are decoded from the code data and are supplied to the at least one MICR printing device, and the MICR data are subsequently printed on the recording medium with exact positioning via the at least one MICR printing device.

The printing devices are operated independently of and separate from one another (thus offline). A special control interface between the printing devices or a synchronization of the printing devices is not required; the recording medium (in particular a paper web) does not need to be continuously transported through both printing devices, but rather can be processed from roll to roll in both printing devices, for example, wherein the color-printed roll generated at the output of the color printing device can be coupled to the MICR printing device as an input roll with an arbitrary time delay for printing with MICR printing material, without a control-related coupling or electronic storage of print data having to occur.

It is advantageous when the code data contain the MICR data and additional information regarding the position of the MICR data on the recording medium. The color printing device can extract the MICR data and their position from the data stream having the color data and the MICR data and encode said MICR data and their position into the code data. For example, the code data can be printed on the recording medium by the color printing device as a 2D barcode.

In order to improve the security in the transmission of the code data, it is advantageous when the code data are supplemented with error correction data (for example Hamming code, Solomon-Reed).

The code data can be read by a reader arranged before the respective MICR printing device and be decoded in the MICR printing device. However, the code data can also be read by a reader arranged outside of the respective MICR printing device and be decoded outside of the MICR printing device, and then can be supplied to the MICR printing device as MICR data together with the position information.

An advantageous use case for the preferred embodiment exists when, for example, check forms are printed on the recording medium by the color printing device. Then it is advantageous when the code data are printed on the recording medium outside of the region for the check forms by the color printing device, for example as barcodes. If the barcodes with the code data associated with a check form are respectively arranged adjacent to the associated check form, the check form is not disruptively affected (to an observer, for example) by the barcode. The barcode can additionally be printed so far into the outer region of one check side that this can be truncated in the course of a subsequent processing of the printed pages of the recording medium, and thus is no longer present on the finished check delivered to the respective recipient.

The code data of multiple check forms can be comprised in the barcode. The color printing device can then print the barcode on the recording medium between the associated check forms.

An advantageous workflow of the method exists when
the data stream with the color data and the MICR data is supplied to the color printing device,
the color printing device extracts the color data from the data stream and prints the color data on the recording medium,
the color printing device extracts the MICR data from the data stream and prints these on the recording medium encoded in a barcode,
the recording medium is supplied to the at least one MICR printing device,
the barcode is read by a reader associated with the at least one MICR printing device, and the MICR data and their position on the recording medium are determined from the read result, and
the at least one MICR printing device prints the MICR data with precise positioning on the recording medium.

The aforementioned problem is also solved via a printing system for printing a recording medium with color data and MICR data,
in which a color printing device and at least one MICR printing device are arranged so as to be mechanically and electrically separated from one another,
in which the color printing device extracts the color data from a data stream supplied to the color printing device and prints said color data on the recording medium,
in which the color printing device extracts the MICR data from the data stream and encodes these in a barcode together with the position of the MICR data on the recording medium, and prints the barcode on the recording medium outside of the region for the color printing,
in which at least one reader is provided that reads the barcode from the recording medium and supplies it to an evaluation unit,
in which the evaluation unit determines the MICR data and their position on the recording medium from the barcode and supplies these to the at least one MICR printing device,
in which the at least one MICR printing device prints the MICR data with precise positioning on the recording medium, corresponding to the determined position information.

And in particular, an optical camera with corresponding evaluation unit that is arranged before the associated MICR printing device can be used as a reader. The code data read by the reader can be decoded via the evaluation unit, for example via a controller (host system) arranged outside of the MICR printing device or via the print controller present in the MICR printing device (which print controller then has to be correspondingly expanded).

The advantages of the preferred embodiments in particular lie in the high performance of the printing system that can be adapted to the respective application case via combination of the color printing device with a selectable number of MICR printing devices. The color printing device can then be operated with maximum speed and utilization, just like the MICR printing device or devices. The offline operation additionally enables a simple implementation capability since the synchronization between the printing devices is omitted and no interface is required.

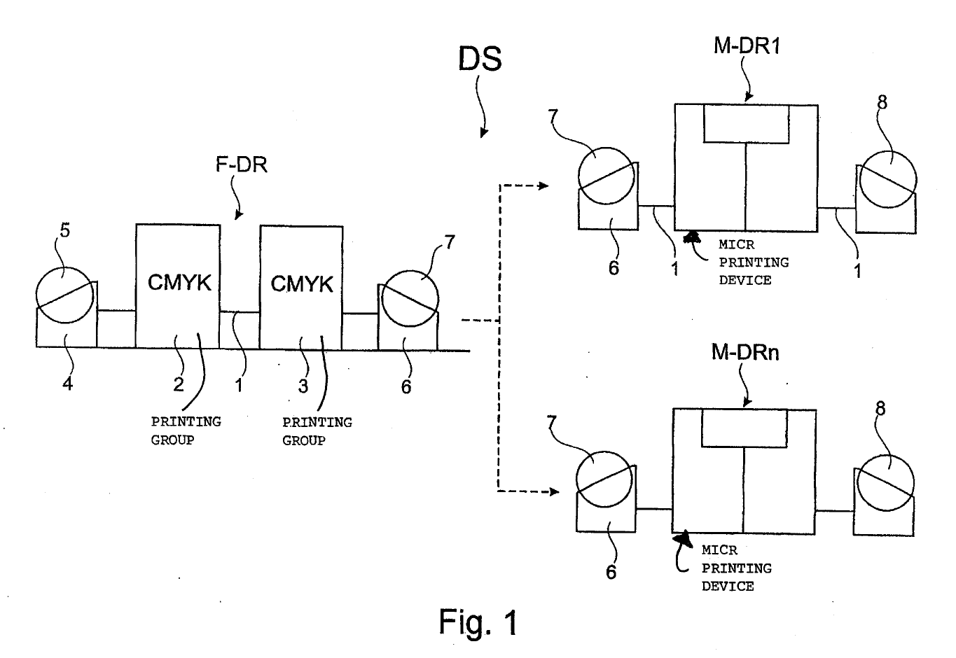

FIG. 1 shows the combination of a color printing device F-DR with MICR printing devices M-DR1 through M-DRn (n=whole number) as a printing system DS. The color printing device F-DR and the MICR printing devices M-DR can be of known design and can be learned from U.S. Pat. No. 6,236,816 B1 or US RE38,957 E, for example. Furthermore, refer to U.S. Pat. No. 6,236,816 B1, US RE38,957 E, U.S. Pat. No. 6,236,816 B1 and US RE38,957 E. The aforementioned publications are herewith incorporated into the disclosure. The number of MICR printing devices M-DR depends on the printing speed of the color printing device F-DR and the printing speed of the MICR printing devices M-DR. The goal of the printing system DS made up of color printing device F-DR and MICR printing devices M-DR is that the color printing device F-DR can operate with its operating speed and the MICR printing devices can additionally process a recording medium 1 printed by the color printing device F-DR without congestion. A printing device with which full colors but also single colors can be printed is thereby designated as a color printing device F-DR.

The color printing device F-DR and the MICR printing devices M-DR are arranged so as to be mechanically and electrically separate from one another and are operated offline. That means that the printed recording medium 1 must first be supplied to the MICR printing devices M-DR after the color printing device F-DR since no connecting unit for the recording medium 1 is provided between color printing device F-DR and MICR printing devices M-DR.

The color printing device F-DR can be realized as a full color printing device and have multiple printing groups 2, 3. For example, one printing group 2 can be provided for the front side of a recording medium 1 (for example a paper web) and one printing group 3 can be provided for the back side. The recording medium 1 is unwound by an unrolling unit 4 with a reservoir roller 5 and supplied to the printing groups 2, 3 of the color printing device F-DR. A rolling unit 6 that collects the recording medium 1 printed with color data on a winding roller 7 is arranged at the output of the printing groups 2, 3. The rolling unit 6 is subsequently supplied to the MICR printing devices M-DR, for example transported to the MICR printing devices that print the recording medium 1 with the MICR data. The recording medium I is supplied from the rolling unit 6 to the MICR printing devices M-DR, printed with MICR data and subsequently fed to an additional rolling unit 8. The recording medium 1 printed with color data and MICR data can be additionally treated in a known manner by devices for post-processing, for example in a cutting device, in a folding device or even in an envelope device (not shown in FIG. 1).

The color printing device F-DR filters the color data and the MICR data from the data stream, which data stream has been supplied in a known manner from a printer control unit to the color printing device F-DR. The data to be printed and the position at which the data are to be printed are yielded by these color data and MICR data. The color data are printed by the color printing device F-DR on the recording medium 1 in a known manner; refer in this regard to U.S. Pat. No. 6,236,816 B1 or US RE38,957 E. The MICR data contain the data to be printed by an MICR printing device M-DR and the position at which the MICR data are to be printed on the recording medium 1. These MICR data are now encoded by the color printing device F-DR as code data, for example in a bar code that then contains the MICR data and the position at which the MICR data should be printed on the recording medium 1. The code data (for example a 2D barcode) are printed by the color printing device F-DR on the recording medium 1, appropriately in a region in which the code data are not disruptive (for example no color data should be printed). The recording medium 1 with color print and code data is removed from the color printing device F-DR and is subsequently supplied to an MICR printing device M-DR. This is shown in principle in FIG. 1 in that the winding roll 6 with the recording medium 1 that contains the code data is transported to the input of an MICR printing device M-DR. There the code data are read and decoded. The MICR printing device M-DR extracts the MICR data and the position at which the MICR data should be printed on the recording medium 1 from the decoded data. The MICR printing device M-DR subsequently prints the MICR data on the recording medium 1. The printing occurs in a known manner, for example as it is described in U.S. Pat. No. 6,236,816 B1 or US RE38,957 E. A reader 13 (for example a camera as it is described in US RE38,957 E; this is referenced) can be used to read the code data.

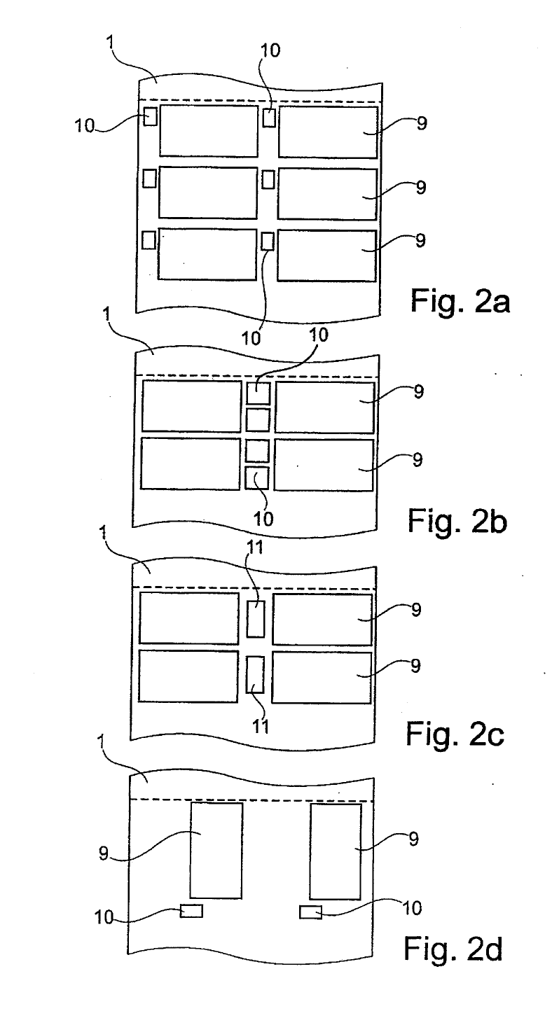

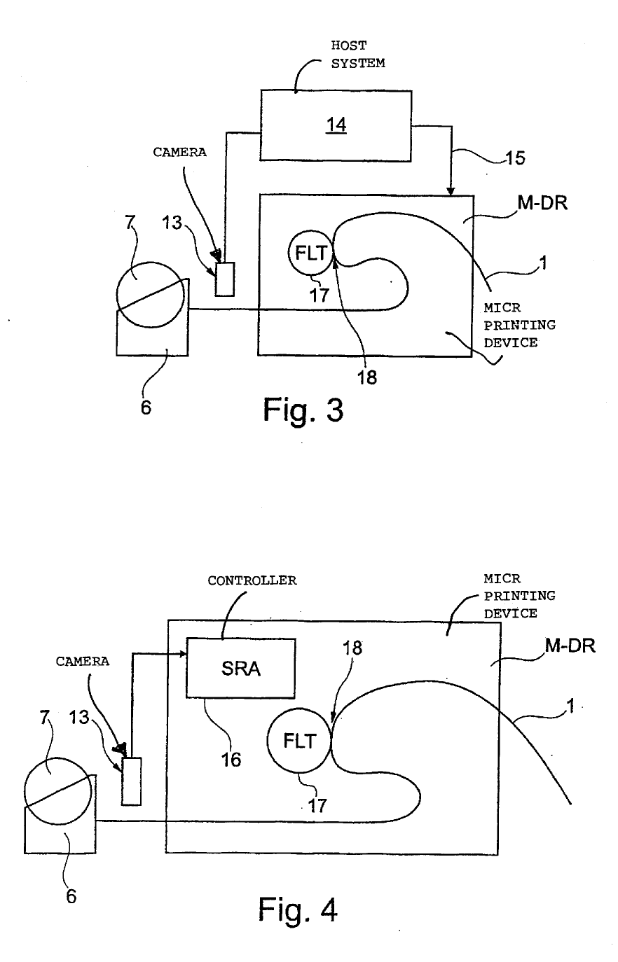

FIG. 2 shows examples for the application of the code data on a recording medium 1. In the exemplary embodiment, check forms 9 are printed on the recording medium 1 by the color printing device F-DR. The code data are encoded in a 2D barcode, for example. Two rows of check forms 9 are shown arranged next to one another in FIG. 2. In FIG. 2 the color printing device F-DR prints a barcode 10 on the recording medium 1 adjacent to the region that is provided for the check forms 9. According to FIG. 2a, the barcode 10 can be printed next to the check forms 9. In FIG. 3B the barcode 10 is imprinted between the check forms 9. A barcode 10 is thereby respectively provided for every check form 9 in FIG. 2a, 2b. However, it is also possible to incorporate the code data for multiple check forms into one barcode. FIG. 2c shows this case. Here the data for two check forms 9 are combined into one barcode 11. The barcode 11 in this case can be arranged between the associated check forms 9. An exemplary embodiment in which the check forms 9 are printed vertically aligned on the recording medium 1 arises from FIG. 2d. Here the barcode 10 can be printed per check form 9 below the associated check form 9.

In all exemplary embodiments of FIG. 2, the barcode 10, 11 is arranged outside of the region that is provided for the printing of the check forms 9. The barcode 10, 11 is therefore not irritating to an observer who is not familiar with the employed barcodes. The barcodes 10, 11 can even be entirely cropped from the check 9 in the course of later additional processing of the recording medium 1 in which the finished printed checks 9 including the MICR print are cut from the recording medium web 1.

According to FIG. 2, the recording medium 1 is supplied to an MICR printing device M-DR, here an electrophotographic MICR printing device that prints with MICR toner; the code data are read, decoded and used as MICR data with position information by the MICR printing device to print the MICR data. For example, the MICR data are imprinted at the provided point in the check form 9. The reader 13 for the code data can be arranged outside or inside the MICR printing device M-DR.

FIGS. 3 and 4 show exemplary embodiments in which a reader 13 is arranged outside of the MICR printing device M-DR. A camera that scans the recording medium 1 before this is supplied to the MICR printing device M-DR is provided as a reader 13, for example.

According to FIG. 3, the code data read by the reader 13 are supplied to a host system 14 arranged outside of the MICR printing device M-DR and are evaluated by this, meaning that the MICR data and their position are determined and then relayed to the MICR printing device M-DR via a data channel 15, which MICR printing device M-DR then prints the MICR data with precise positioning on the recording medium 1 (for example in the form of a check form 9).

FIG. 4 shows the case in which the reader 13 is connected with a controller 16 (for example a printer controller) arranged as an evaluation unit in the MICR printing device M-DR. The controller 16 decodes the code data and extracts the MICR data and their position on the recording medium 1 from these. The MICR data are subsequently printed on the recording medium 1.

The reader 13 and the controller 16 or the host system 14 can be designed corresponding to US RE38,957 E; this is referenced.

Of the MICR printing device M-DR in FIG. 3 and 4 only the charge image carrier 17 (for example a photoconductor drum) and the path of the recording medium 1 through the printing device M-DR are shown in principle. The recording medium 1 is directed past a charge image carrier 17 in a transfer printing zone 18. In operation, the reading of the code data by the reader 13 must be synchronized with the printing of the MICR data on the recording medium 1 so that the MICR data are printed at the correct point on the recording medium 1. For example, if a new recording medium roll 7 is supplied to an MICR printing device M-DR, how many pages lie between reader 13 and transfer printing zone 18 must be known since the transfer printing of the MICR data on the recording medium 1 may only occur when the page with the MICR data to be printed has arrived in the transfer printing zone 18. If a check form 9 with barcode 10 corresponding to FIG. 2 has been printed on the recording medium 1, for example, the barcode 10 is read by the reader 13 and the MICR data and their position are determined from this. However, the printing of the MICR data in the associated check form 9 can only occur when the recording medium 1 with the check form 9 has been transported into the transfer printing zone 18.

The preferred embodiment has in particular been described in the example of the printing of an recording medium 1 with check forms 9 and MICR data. However, the preferred embodiment is not limited to this. The preferred can be used anywhere that color data and MICR data should be printed on a recording medium 1.

Although in the drawings and in the foregoing description preferred exemplary embodiments have been indicated and described in detail, these are to be understood as purely exemplary, and not as limiting the present invention. It is to be noted that only the preferred exemplary embodiments have been presented and described, and that all modifications and changes lying within the scope of protection of the present invention, currently and in the future, are intended to be protected.

I claim as my invention:

1. A method for printing a recording medium with color data and MICR data, comprising the steps of:
printing with the color printing device both the color data and the MICR data in encoded form as code data onto the recording medium;
supplying the recording medium to the at least one MICR printing device; and
decoding the MICR data from the code data, and subsequently printing the MICR data on the recording medium with precise positioning via the at least one MICR printing device.

2. A method according to claim 1 in which the code data contain the MICR data and a position of the MICR data on the recording medium.

3. A method according to claim 1 in which the code data are supplemented with error correction data.

4. A method according to claim 1 in which the color printing device extracts the MICR data and their position from a data stream containing the color data and the MICR data and encodes said MICR data and their position into the code data.

5. A method according to claim 1 in which the code data are printed as a barcode on the recording medium by the color printing device.

6. A method according to claim 1 in which the code data are read by a reader arranged before the respective MICR printing device and are decoded in the respective MICR printing device.

7. A method according to claim 1 in which the code data are read by a reader arranged before the respective MICR printing device, are decoded outside of the respective MICR printing device, and are supplied to the respective MICR printing device as MICR data.

8. A method according to claim 1 in which check forms are printed on the recording medium by the color printing device, and in said check forms the code data are printed on the recording medium outside of a region for the check forms by the color printing device.

9. A method according to claim 8 in which the code data associated with a respective check form are respectively arranged adjacent to the check form.

10. A method according to claim 8 in which the code data of multiple check forms are comprised in a barcode, and the color printing device prints the barcode on the recording medium between the associated check forms.

11. A method according to claim 1 in which:
a data stream with the color data and the MICR data is supplied to the color printing device;
the color printing device extracts the color data from the data stream and prints the color data on the recording medium;
the color printing device extracts the MICR data from the data stream and prints the data on the recording medium encoded in a barcode;
the recording medium is supplied to the respective MICR printing device;
the barcode is read by a reader associated with the respective MICR printing device, and the MICR data and their position on the recording medium are determined from a read result; and
the respective MICR printing device prints the MICR data with precise positioning on the recording medium corresponding to the determined position information.

12. A printing system for printing a recording medium with color data, comprising:
a color printing device and at least one MICR printing device are arranged to be mechanically and electrically separated from one another;
the color printing device extracting the color data from a data stream supplied to the color printing device and printing said color data on the recording medium;
the color printing device also extracting the MICR data from the data stream and encoding the data in a barcode together with a position of said MICR data on the recording medium, and printing the barcode on the recording medium outside of the region for the color printing;
a reader is associated with the respective MICR printing device, said reader reading the barcode from the recording medium;
an evaluation unit that determines the MICR data and their position on the recording medium from the barcode and supplies the data and their position to the respective MICR printing device; and
the respective MICR printing device printing the MICR data with precise positioning on the recording medium.

13. A printing system according to claim 12 in which the reader comprises a camera.

14. A printing system according to claim 12 in which the color printing device comprises an inkjet printing device.

15. A method for printing a recording medium with color data and MICR data, comprising the steps of:
printing with the color printing device both the color data and the MICR data in encoded form as code data onto the recording medium;
supplying the recording medium to the at least one MICR printing device; and
decoding the MICR data from the code data, and subsequently printing the MICR data on the recording medium via the at least one MICR printing device.
